(19) United States
(12) Patent Application Publication
(10) Pub. No.: US 2010/0319849 A1
(43) Pub. Date: Dec. 23, 2010

(54) METHOD AND SYSTEM FOR FAST FABRICATING GLUED LAMINATED TIMBER

(75) Inventor: Jan Dong Lin, Kaohsiung (TW)

Correspondence Address: WPAT, PC;INTELLECTUAL PROPERTY ATTORNEYS, 2030 MAIN STREET, SUITE 1300, IRVINE, CA, 92614, US

(73) Assignee: DONGGUAN CAMBRIDGE FURNITURE CO., LTD., GuangDong (CN)

(21) Appl. No.: 12/488,819

(22) Filed: Jun. 22, 2009

(51) Int. Cl. B32B 37/12; B32B 37/10

(52) U.S. Cl. 156/325; 156/580; 156/349

(57) ABSTRACT

A method for fast fabricating a glued laminated timber is provided. The method includes the following steps: preparing a plurality of prelaminating pieces, each of the prelaminating pieces having at least two laminating surfaces, arranging the prelaminating pieces to position the laminating surfaces substantially perpendicular with a horizontal plane, and uniformly distributing glue onto the laminating surfaces of the prelaminating pieces; drying the prelaminating pieces having glue distributed thereon to precuring the glue distributed on the laminating surfaces; sequentially stacking the prelaminating pieces one on another to obtain a stack, wherein each of the prelaminating pieces is stacked to another with its laminating surfaces only; conducting a compression treatment to the stack and maintaining the compression treatment for a certain time to obtain a glued laminated timber preform; and conducting a drying treatment to the glued laminated timber preform to obtain the glued laminated timber.

### BACKGROUND OF THE INVENTION

1. Field of the Invention

The present invention relates generally to a method and a device for fabricating a glued laminated material, and more particularly, to a method and a system for fast fabricating a glued laminated timber.

2. The Prior Arts

Currently, because of the cheaper price and environmental friendly feature, glued laminated timbers are now widely used in many fields including architectural field. FIG. 1 is a schematic diagram illustrating a conventional manual method for distributing glue. FIG. 2 is a schematic diagram illustrating a conventional semi-automatic method for distributing glue. Referring to FIGS. 1 and 2, a conventional method for fabricating a glued laminated timber mainly includes the following steps. At first, a plurality of prelaminating pieces 1 are manually delivered over a glue distributing roller 2 as shown in FIG. 1, or are semi-automatically delivered by a conveying apparatus 3 for passing by the glue distributing roller 2, in which the glue distributing roller 2 distributes a glue onto a laminating surface of each of the prelaminating pieces 1. The glued prelaminating pieces 1 are then sequentially stacked one to another to obtain a stack. The stack is then processed with a compression treatment. Finally, the stack is then immediately conducted with an air-drying treatment and a temperature control drying treatment, thus obtaining a glued laminated timber product.

However, the aforementioned conventional technology has some disadvantages. Firstly, the amount of distributing the glue onto the prelaminating pieces is hard to control. When insufficient glue is provided, the obtained glued laminated timber product may be bonded with an insufficient bondability between the prelaminating pieces for locally lack of glue. On the contrary, when excessive glue is provided, the glue often flows from the prelaminating pieces down to the operation console, thus causing a contamination thereto. Further, when the glued prelaminating pieces are then sequentially stacked one to another and conducted with the compression treatment, the glue often extravasates from the between of neighboring prelaminating pieces and contaminate the operation console. Even worse, the extravasated glue may remain on the surface of the glued laminated timber product, and thus make it difficult to grind or polish the surface of the glued laminated timber product. Further, the conventional compressing machine as shown in FIG. 3 includes an oil hydraulic system or an air pressure system for conducting the compression treatment. However, such an oil hydraulic system or air pressure system is hard to precisionally control. Moreover, after the compression treatment, the glue between the prelaminating pieces is not completely solidified, and therefore the stack must be sustained with a compression treatment and a stacking drying process as shown in FIG. 4 for 2 to 4 hours. The entire process is complex and lengthy, while occupying a large lot, which is very inconvenient.

### SUMMARY OF THE INVENTION

A primary objective of the present invention is to provide a method for fast fabricating a glued laminated timber. The method of the present invention is adapted for effectively controlling the amount of providing the glue for avoiding the contamination caused by excessively used glue. The method is simple, convenient, requires for a short time and a small lot, and has a low fabrication cost.

A further objective of the present invention is to provide a system for fast fabricating a glued laminated timber. The system is structurally simple and adapted for mass production.

For achieving the foregoing objectives and others, the present invention provides a method for fast fabricating a glued laminated timber. The method comprises the following steps:

1. preparing a plurality of prelaminating pieces, each of the prelaminating pieces having at least two laminating surfaces, arranging the prelaminating pieces to position the laminating surfaces substantially perpendicular with a horizontal plane, and uniformly distributing glue onto the laminating surfaces of the prelaminating pieces;

2. drying the prelaminating pieces having glue distributed thereon to precuring the glue distributed on the laminating surfaces;

3. sequentially stacking the prelaminating pieces one on another to obtain a stack, in which each of the prelaminating pieces is stacked to another with its laminating surfaces only;

4. conducting a compression treatment to the stack and maintaining the compression treatment for a certain time to obtain a glued laminated timber preform; and

5. conducting a drying treatment to the glued laminated timber preform to obtain the glued laminated timber.

Specifically, the step 1 includes: arranging the prelaminating pieces to position the laminating surfaces of the prelaminating pieces substantially perpendicular with the horizontal plane, and sequentially conveying the prelaminating pieces to pass through a vertical glue distributing mechanism, in which the vertical glue distributing mechanism includes at least two erect glue distributing rollers, and when any of the prelaminating pieces having two laminating surfaces passes between the two erect glue distributing rollers, the two laminating surfaces are positioned substantially tangent to outmost surfaces of the two erect glue distributing rollers, respectively.

The step 2 includes: loading the prelaminating pieces into an environment having a temperature ranging from 30° C. to 60° C., and air drying the laminating surfaces of the prelaminating pieces having glue distributed thereon to remove 30% to 70% of water content contained in the glue distributed on the laminating surfaces.

The steps 4 and 5 include: applying pressures from end side surfaces and lateral side surfaces of the stack, respectively, to obtain the glued laminated timber preform, in which the pressures are substantially perpendicular with the end side surfaces and lateral side surfaces of the stack, and strengths of the pressures and times of applying the pressures are variable in accordance with particular specification of the prelaminating pieces and other factors; and removing the pressures, and conducting an air drying treatment and a temperature controlled drying process to the glued laminated timber preform to obtain the glued laminated timber.

More specifically, the method includes the steps of:

preparing a plurality of prelaminating pieces, each of the prelaminating pieces having two laminating surfaces, arranging the prelaminating pieces to position the laminating surfaces substantially perpendicular with a horizontal plane, and sequentially delivering the prelaminating pieces to pass through a vertical glue distributing mechanism for uniformly distributing glue onto the laminating surfaces of the prelaminating pieces;

loading the prelaminating pieces into a precuring zone having a temperature ranging from 30° C. to 60° C., and using an air blower to provide an airflow sweeping over the laminating surfaces of the prelaminating pieces having glue distributed thereon to remove 30% to 70% of water content contained in the glue distributed on the laminating surfaces;

loading the prelaminating pieces into a stacking zone, and sequentially stacking the prelaminating pieces one on another to obtain a stack, in which each of the prelaminating pieces is stacked to another with its laminating surfaces only;

applying pressures from end side surfaces and lateral side surfaces of the stack, respectively, to obtain the glued laminated timber preform, in which the pressures are substantially perpendicular with the end side surfaces and lateral side surfaces of the stack; and

conducting a drying treatment to the glued laminated timber preform to obtain the glued laminated timber.

The present invention further provides a system for fast fabricating a glued laminated timber. The system includes a glue distributing unit, a composer unit, and an aging and drying unit. The system further includes a precuring unit. The glue distributing unit, the precuring unit, the composer unit, and the aging and drying unit are sequentially arranged in a production line, for sequentially producing a stack of prelaminating pieces, a glued laminated timber preform, and a final product of glued laminated timber. The precuring unit is a temperature controlled room maintained with a temperature ranging from 30° C. to 60° C. The precuring unit is further equipped with an air blower.

Specifically, the glue distributing unit includes a vertical glue distributing mechanism. The vertical glue distributing mechanism includes at least two erect glue distributing rollers. When any of the prelaminating pieces having two laminating surfaces passes through the vertical glue distributing mechanism while the laminating surfaces thereof are maintained perpendicular with the horizontal plane, the two laminating surfaces are positioned substantially tangent to outmost surfaces of the two erect glue distributing rollers, respectively.

The glue distributing unit further includes a conveying mechanism. The conveying mechanism includes at least two erectly disposed conveying rollers. When any of the prelaminating pieces having two laminating surfaces passes through the conveying mechanism and the vertical glue distributing mechanism while the laminating surfaces thereof are maintained perpendicular with the horizontal plane, the two laminating surfaces are positioned substantially tangent to outmost surfaces of the conveying rollers and the two erect glue distributing rollers, respectively.

The composer unit further includes a composer machine. The composer machine includes composer workpieces, mandrils, and a driving apparatus thereof. When the composer machine is used for conducting the compression treatment to the stack, the stack is arranged on an operation console of the composer machine in that the laminating surfaces of the prelaminating pieces are positioned substantially perpendicular with the horizontal plane. The composer workpieces are provided at two outmost laminating surfaces of the prelaminating pieces and upper end sides of the prelaminating pieces. The mandrils is driven by the driving apparatus to actuate the workpieces to push against the stack, thus applying pressures in directions perpendicular with the laminating surfaces and the horizontal plane, respectively.

The aging and drying unit includes a circulating drying apparatus. The circulating drying apparatus includes an elliptical conveying belt, and a plurality of aging shelves connected to the conveying belt. The aging shelves are adapted for carrying the glued laminated timber preforms. The circulating drying apparatus is installed in a temperature controlled room, in which air blower equipment is further provided around the conveying belt.

According to the present invention, the glue is coated to both laminating surfaces of each of the prelaminating pieces. Then, prior to stacking the prelaminating pieces, the glue distributed on the prelaminating pieces is conducted with a semi-curing treatment in advance. In such a way, the glue coated on the laminating surfaces of the prelaminating pieces can be uniformly distributed, and the extravasation of the glue can be avoided when compressing the stack. Meanwhile, the glue is cured during the process of laminating, so that the prelaminating pieces can be solidly bonded together. In such a way, not only the production cycle can be shortened, and less production lot is required, but also the quality of the final products can be guaranteed.

Furthermore, the present invention employs a vertical dual surface glue distributing method which is adapted for executing with a constant speed and supplying the glue, so that the glue coated on the laminating surfaces can be uniformly distributed. In such a way, the present invention is adapted for avoiding partial lack of glue and extravasation of the glue, thus saving the consumption of the glue and improving the quality of the final products.

According to an aspect of the present invention, the precuring process conducted to the glue distributed on the prelaminating pieces is discussed in more details as following. The prelaminating pieces are automatically and uniformly arranged one apart from another for a certain distance. The prelaminating pieces are then loaded to a temperature controlled room. The temperature controlled room is equipped with an air blower for providing an airflow sweeping over the laminating surfaces of the prelaminating pieces having glue distributed thereon for accelerating the solidification of the glue and removing about 30% to 70% of water content contained in the glue distributed on the laminating surfaces. Such a precuring process can be completed with simple and conventional equipment in a short time.

After being precured, the prelaminating pieces are fast stacked into a stack. The stack is then delivered by an automatic conveying apparatus to the laminating zone. The prelaminating pieces are continuously loaded into the composer machine until a predetermined amount of the prelaminating pieces is reached. A compressing system of the composer machine is then turned on to apply pressures to the prelaminating pieces. When the pressures are applied to the laminating surfaces, semi-cured glue therebetween is impacted and instantly generated with a large amount of heat. This heat speeds up the solidification of the semi-cured glue. After remaining the pressure for a certain time, the glue between the laminating surfaces can be fast and completely solidified. And therefore, the prelaminating pieces are bonded one to another with a very strong bondability, thus improving the strength of the glued laminated timber product. Further, the present invention effectively prevents the extravasation of the glue during the compression treatment, thus preventing the contamination caused to the operation console, and reducing the difficulty of grinding or polishing the glued laminated timber product. Furthermore, the present invention proposes the precuring treatment and the continuously compression treatment, thus providing a solution to the difficulty of the conventional composer machine that is the pressure applied to the prelaminating pieces gradually decreases which may cause the subsequently obtained glued laminated timber product crack. The time of remaining the pressures to the prelaminating pieces is determined in accordance with the thickness of the prelaminating pieces.

In fact, a conventional composer machine can also be complied with the present invention. Preferably, the composer machine is composed of composer workpieces, mandrils, and a driving apparatus (e.g., oil hydraulic system or air pressure system. In operation, the mandrils are driven by the driving apparatus to push against the composer workpieces disposed on the prelaminating pieces, so as to apply pressures from a plurality of directions to the prelaminating pieces. Comparing with the aforementioned conventional technologies, the compressing system according to the present invention is structurally simple and convenient for operation, and is adapted for applying pressures from a plurality of pressured to the prelaminating pieces, so that the strength of the final product can be guaranteed.

After the compression treatment, the pressures can be then released. A temperature controlled air drying treatment is then conducted for 10 to 30 minutes, thus obtaining the final products of the glued laminated timber. Preferably, the equipment used for conducting the air drying treatment is adapted for automatically circulation. Comparing with the conventional technology, which requires for a drying treatment lasting 2 to 4 hours, and manual loading and unloading, the present invention saves labor, time, and production lot, and can improve the working efficiency for about 5 to 10 times.

Comparing with the conventional technology, the present invention has the following advantages: effectively controlling the amount of applying the glue, avoiding the contamination to the operation console and the product surface caused by the extravasation of the glue, simplified fabrication process, shortened production cycle, requiring smaller production lot, and the system for fast fabricating a glued laminated timber has a simple structure, is convention for operation, and is adapted for processing products of a plurality of specifications. The present invention can be widely employed in architectural and furniture industries, and can save production cost and improve operation efficiency thereof.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is a schematic diagram illustrating a conventional manual method for distributing glue;

FIG. 2 is a schematic diagram illustrating a conventional semi-automatic method for distributing glue;

FIG. 3 is a schematic diagram illustrating a conventional technology for fabricating a glued laminated timber;

FIG. 4 is a schematic diagram illustrating a structure of a conventional aging and drying unit;

FIG. 5 is a flow chart illustrating a method for fast fabricating a glued laminated timber according to an embodiment of the present invention;

FIG. 6 is a structural schematic diagram illustrating a vertical glue distributing mechanism of a system for fast fabricating a glued laminated timber according to an embodiment of the present invention;

FIG. 7 is a structural schematic diagram illustrating a pressure applying mechanism of the system according to an embodiment of the present invention; and

FIG. 8 is a structural schematic diagram illustrating a circulating drying apparatus of the system according to an embodiment of the present invention.

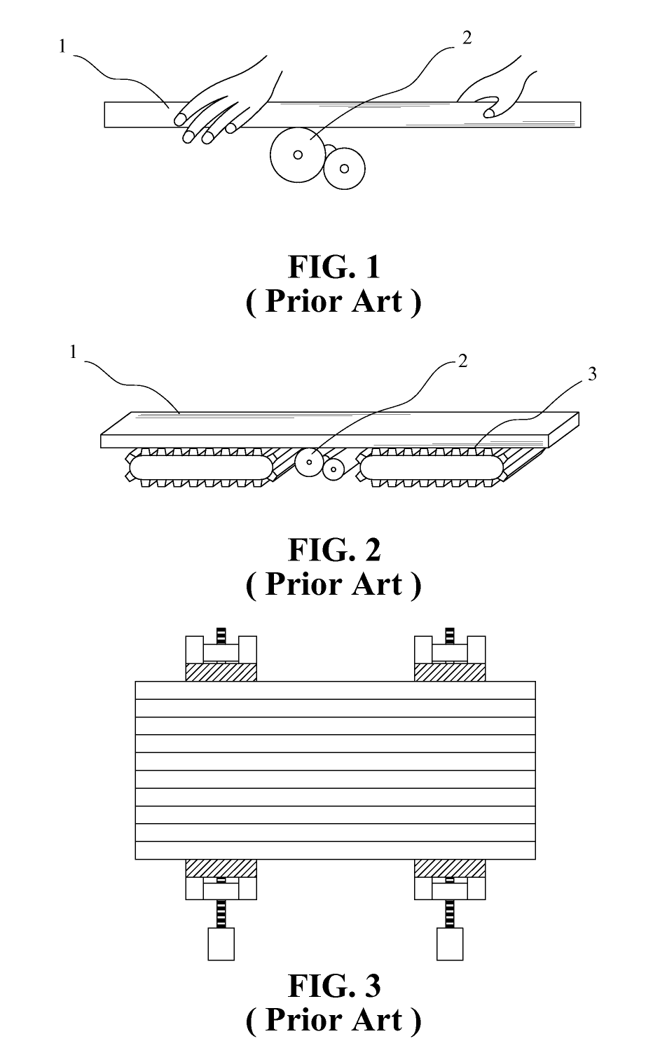

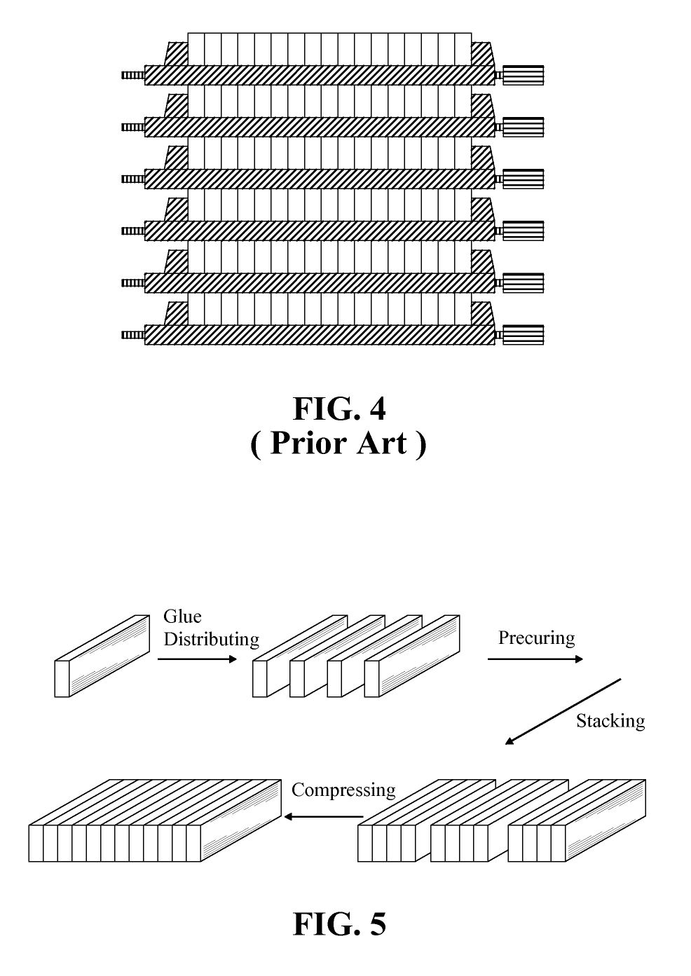

### DETAILED DESCRIPTION OF THE PREFERRED EMBODIMENT

The accompanying drawings are included to provide a further understanding of the invention, and are incorporated in and constitute a part of this specification. The drawings illustrate embodiments of the invention and, together with the description, serve to explain the principles of the invention.

FIG. 5 is a flow chart illustrating a method for fast fabricating a glued laminated timber according to an embodiment of the present invention. Referring to FIG. 5, the method includes the following steps:

preparing a plurality of prelaminating pieces, each of the prelaminating pieces having at least two laminating surfaces, arranging the prelaminating pieces to position the laminating surfaces substantially perpendicular with a horizontal plane, and uniformly distributing glue onto the laminating surfaces of the prelaminating pieces;

drying the prelaminating pieces having glue distributed thereon to precuring the glue distributed on the laminating surfaces;

sequentially stacking the prelaminating pieces one on another to obtain a stack, in which each of the prelaminating pieces is stacked to another with its laminating surface only;

conducting a compression treatment to the stack and maintaining the compression treatment for a certain time to obtain a glued laminated timber preform; and

conducting a drying treatment to the glued laminated timber preform to obtain the glued laminated timber.

The method is preferably conducted with a system for fast fabricating the glued laminated timber. The system includes a glue distributing unit 4, a precuring unit, a composer unit 5, and an aging and drying unit 6. The glue distributing unit 4, the precuring unit, the composer unit 5, and the aging and drying unit 6 are sequentially arranged in a production line, for sequentially producing a stack of prelaminating pieces, a glued laminated timber preform, and a final product of the glued laminated timber.

More details of using the system for conducting the method for fast fabricating the glued laminated timber is to be discussed in more details herebelow.

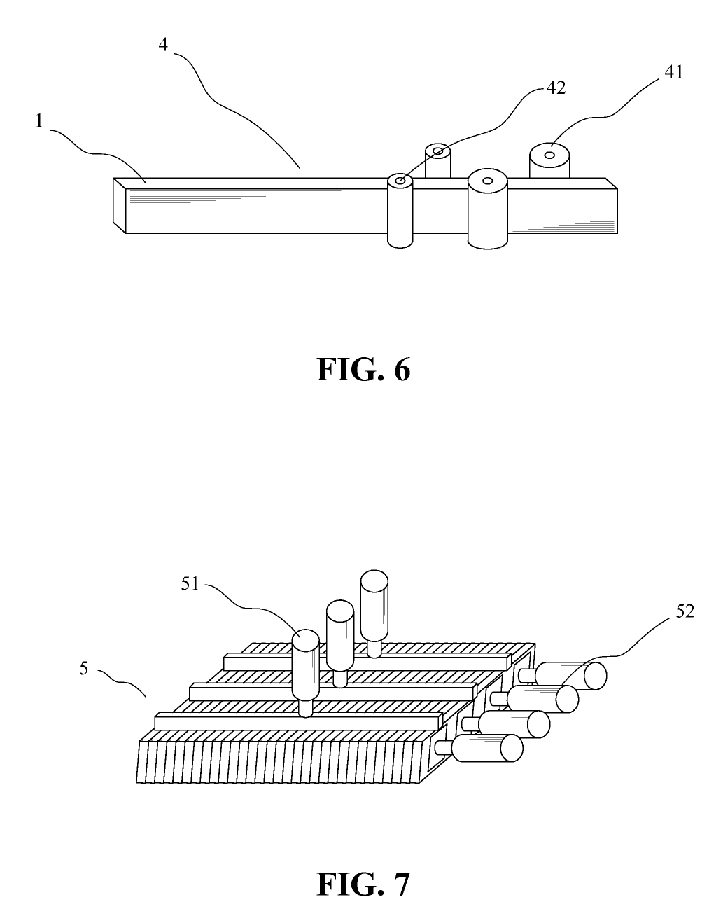

At first, a plurality of prelaminating pieces are arranged such that laminating surfaces of the prelaminating pieces are positioned substantially perpendicular with the horizontal plane. The prelaminating pieces are then conveyed to pass through a glue distributing unit, during which the glue are uniformly distributed onto the laminating surfaces of prelaminating pieces. The glue distributing unit includes a conveying mechanism 41 and a vertical glue distributing mechanism 42. As shown in FIG. 6, the conveying mechanism 41 includes at least two erectly disposed conveying rollers, and the vertical glue distributing mechanism 42 at least two erectly disposed glue distributing rollers. When the prelaminating pieces are conveyed passing through the conveying mechanism 41 and the vertical glue distributing mechanism 42 while the laminating surfaces are maintained substantially perpendicular with the horizontal plane, the two laminating surfaces are positioned substantially tangent to outmost surfaces of the two erect glue distributing rollers, respectively.

The glued prelaminating pieces are then automatically loaded to a precuring unit. The precuring unit is preferably a temperature controlled room maintained with a temperature ranging from 30° C. to 60° C. An air blower is further provided in the temperature controlled room for providing an air flow sweeping over the laminating surfaces of the glued prelaminating pieces for removing about 30% to 70% of water content contained in the glue distributed on the laminating surfaces.

The glued prelaminating pieces are then loaded to the composer unit 5. The prelaminating pieces are stacked one on another to obtain a stack, in which each of the prelaminating pieces is stacked to another with its laminating surfaces only.

The stack of the glued prelaminating pieces is positioned on an operation console of the composer machine, in which the laminating surfaces of the glued prelaminating pieces are maintained substantially perpendicular with the horizontal plane. The composer workpiece 51 and 52 are provided at two outmost laminating surfaces of the prelaminating pieces and upper end sides of the prelaminating pieces. The mandrils is driven by the driving apparatus to actuate the workpieces to push against the stack, thus applying pressures in directions perpendicular with the laminating surfaces and the horizontal plane, respectively, as shown in FIG. 7. The pressures and the time of applying the pressures are determined in accordance with the specification of the prelaminating pieces. The pressures are maintained for a certain time until obtaining a glued laminated timber preform.

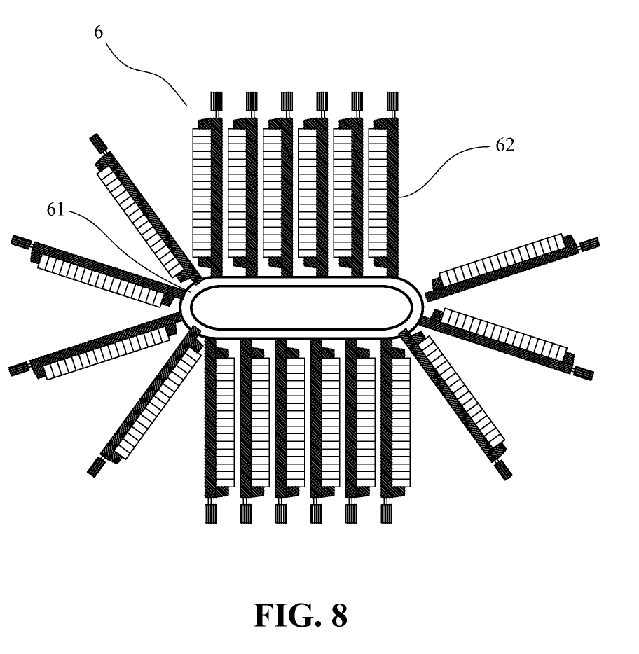

The pressures then are released from the glued laminated timber preform, and then the glued laminated timber preform is conducted with an aging and drying treatment for about 10 to 30 minutes. FIG. 8 is a structural schematic diagram illustrating a circulating drying apparatus of the system according to an embodiment of the present invention. As shown in FIG. 8, a circulating drying apparatus is employed for performing an air drying and temperature controlled drying treatment. The circulating drying apparatus includes an elliptical conveying belt 61, and a plurality of aging shelves 62 connected to the conveying belt. The aging shelves are adapted for carrying the glued laminated timber preforms. The circulating drying apparatus is installed in the temperature controlled room, in which air blower equipment is further provided around the conveying belt.

The present invention has the following advantages: effectively controlling the amount of applying the glue, avoiding the contamination to the operation console and the product surface caused by the extravasation of the glue, simplified fabrication process, shortened production cycle, requiring smaller production lot, and the system for fast fabricating a glued laminated timber has a simple structure, is convention for operation, and is adapted for processing products of a plurality of specifications.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A method for fast fabricating a glued laminated timber, comprising the steps of:
(1) preparing a plurality of prelaminating pieces, each of the prelaminating pieces having at least two laminating surfaces, arranging the prelaminating pieces to position the laminating surfaces substantially perpendicular with a horizontal plane, and uniformly distributing glue onto the laminating surfaces of the prelaminating pieces;
(2) drying the prelaminating pieces having glue distributed thereon to precuring the glue distributed on the laminating surfaces;
(3) sequentially stacking the prelaminating pieces one on another to obtain a stack, wherein each of the prelaminating pieces is stacked to another with its laminating surfaces only;
(4) conducting a compression treatment to the stack and maintaining the compression treatment for a certain time to obtain a glued laminated timber preform; and
(5) conducting a drying treatment to the glued laminated timber preform to obtain the glued laminated timber.

2. The method according to claim 1, wherein the step (1) further comprises:
arranging the prelaminating pieces to position the laminating surfaces of the prelaminating pieces substantially perpendicular with the horizontal plane, and sequentially conveying the prelaminating pieces to pass through a vertical glue distributing mechanism, wherein the vertical glue distributing mechanism comprises at least two erect glue distributing rollers, and when any of the prelaminating pieces having two laminating surfaces passes between the two erect glue distributing rollers, the two laminating surfaces are positioned substantially tangent to outmost surfaces of the two erect glue distributing rollers, respectively.

3. The method according to claim 1, wherein the step (2) further comprises:
loading the prelaminating pieces into an environment having a temperature ranging from 30° C. to 60° C., and air drying the laminating surfaces of the glued prelaminating pieces to remove 30% to 70% of water content contained in the glue distributed on the laminating surfaces.

4. The method according to claim 1, wherein the steps (4) and (5) further comprise:
applying pressures from end side surfaces and lateral side surfaces of the stack, respectively, to obtain the glued laminated timber preform, wherein the pressures are substantially perpendicular with the end side surfaces and lateral side surfaces of the stack, and strengths of the pressures and times of applying the pressures are variable in accordance with particular specification of the prelaminating pieces; and
removing the pressures, and conducting an air drying treatment and a temperature controlled drying process to the glued laminated timber preform to obtain the glued laminated timber.

5. A method for fast fabricating a glued laminated timber, comprising the steps of:
preparing a plurality of prelaminating pieces, each of the prelaminating pieces having two laminating surfaces, arranging the prelaminating pieces to position the laminating surfaces substantially perpendicular with a horizontal plane, and sequentially delivering the prelaminating pieces to pass through a vertical glue distributing mechanism for uniformly distributing glue onto the laminating surfaces of the prelaminating pieces;
loading the prelaminating pieces into a precuring zone having a temperature ranging from 30° C. to 60° C., and using an air blower to provide an airflow sweeping over the laminating surfaces of the prelaminating pieces having glue distributed thereon to remove 30% to 70% of water content contained in the glue distributed on the laminating surfaces;
loading the prelaminating pieces into a stacking zone, and sequentially stacking the prelaminating pieces one on another to obtain a stack, wherein each of the prelaminating pieces is stacked to another with its laminating surfaces only;
applying pressures from end side surfaces and lateral side surfaces of the stack, respectively, to obtain the glued laminated timber preform, wherein the pressures are substantially perpendicular with the end side surfaces and lateral side surfaces of the stack; and
conducting a temperature controlled drying treatment to the glued laminated timber preform to obtain the glued laminated timber.

6. A system for fast fabricating a glued laminated timber adapted for conducting the method as claimed in claim 1, comprising a glue distributing unit, a precuring unit, a composer unit, and a aging and drying unit sequentially arranged in a production line, for sequentially producing a stack of prelaminating pieces, a glued laminated timber preform, and a final product of glued laminated timber, wherein the precuring unit is a temperature controlled room maintained with a temperature ranging from 30° C. to 60° C., and the precuring unit is further equipped with an air blower.

7. The system according to claim 6, wherein the glue distributing unit comprises a vertical glue distributing mechanism, and the vertical glue distributing mechanism comprises at least two erect glue distributing rollers, wherein when any of the prelaminating pieces having two laminating surfaces passes through the vertical glue distributing mechanism while the laminating surfaces thereof are maintained perpendicular with the horizontal plane, the two laminating surfaces are positioned substantially tangent to outmost surfaces of the two erect glue distributing rollers, respectively.

8. The system according to claim 7, wherein the glue distributing unit further comprises a conveying mechanism, and the conveying mechanism comprises at least two erectly disposed conveying rollers, wherein when any of the prelaminating pieces having two laminating surfaces passes through the conveying mechanism and the vertical glue distributing mechanism while the laminating surfaces thereof are maintained perpendicular with the horizontal plane, the two laminating surfaces are positioned substantially tangent to outmost surfaces of the conveying rollers and the two erect glue distributing rollers, respectively.

9. The system according to claim 6, wherein the composer unit further comprises a composer machine, and the composer machine comprises composer workpieces, mandrils, and a driving apparatus thereof, wherein when the composer machine is used for conducting the compression treatment to the stack, the stack is arranged on an operation console of the composer machine such that the laminating surfaces of the prelaminating pieces are positioned substantially perpendicular with the horizontal plane, and the composer workpieces are provided at two outmost laminating surfaces of the prelaminating pieces and upper end sides of the prelaminating pieces, and the mandrils is driven by the driving apparatus to actuate the workpieces to push against the stack, thus applying pressures in directions perpendicular with the laminating surfaces and the horizontal plane, respectively.

10. The system according to claim 9, wherein the aging and drying unit comprises a circulating drying apparatus, and the circulating drying apparatus comprises an elliptical conveying belt, and a plurality of aging shelves connected to the conveying belt, wherein the aging shelves are adapted for carrying the glued laminated timber preforms, and the circulating drying apparatus is installed in a temperature controlled room, and an air blower is provided nearby the conveying belt.
